(19) United States
(12) Patent Application Publication
(10) Pub. No.: US 2003/0146151 A1
(43) Pub. Date: Aug. 7, 2003

(54) Sintered magnesium oxide filter

(76) Inventors: Feng Chi, Greer, SC (US); Leonard S. Aubrey, Arden, NC (US)

Correspondence Address: Joseph T. Guy, Ph.D., Nexsen Pruet Jacobs & Pollard, LLC, PO Drawer 10648, Greenville, SC, 29603-0648, US

(21) Appl. No.: 10/055,219

(22) Filed: Jan. 23, 2002

(51) Int. Cl. B01D 39/06

(52) U.S. Cl. 210/510.1

(57) ABSTRACT

A filter which is particularly well suited for filtering magnesium and magnesium alloys prepared by the process of:

a) forming a slurry comprising a ceramic component wherein the ceramic component comprises:

50-99.5%, by weight, magnesium measured as the oxide; and

0.5-50%, by weight, at least one sintering aid selected from a group consisting of TiO₂, ZrO₂, CaO₂, SiO₂, Al₂O₃ and Fe₂O₃;

b) coating the slurry on an open cell organic foam material to form a coated material;

c) heating the coated material at a temperature sufficient to burn off the open cell organic foam material to form a structure; and

d) sintering said structure to form said filter.

### TECHNICAL FIELD

The present invention is related to a ceramic filter which is particularly suitable for use in filtering molten magnesium, magnesium alloys as well as other alloys such as nickel based superalloys and steel produced in basic or neutral slag environments. More specifically, the present invention is directed to a magnesium oxide filter which comprises sintering aids which greatly increase the utility of the magnesium oxide filter.

### BACKGROUND

Filtration purification of molten metals is a well known process. Filtering removes entrained solids which are detrimental to the eventual use of the metal. Filters must be capable of withstanding the high temperatures without degradation and they must be sufficiently rigid to avoid breakage during the filtering operation.

Magnesium alloys have received renewed interest as a material of construction in a variety of applications. A strength to weight ratio can be obtained which allows magnesium alloys to be considered as a viable replacement for certain high density plastics at competitive prices.

Filtering of molten magnesium, or magnesium alloys, is difficult due to the high level of reactivity of magnesium metal. Typically available ceramic filters, such as aluminum oxide, zirconium oxide, silicon carbide and phosphate bonded alumina are not suitable for continuous prolonged exposure because the filters react with molten magnesium. Silicon carbide and phosphate bonded alumina, for example, fail within approximately 30 minutes after being immersed in magnesium. This is obviously not acceptable.

Filter elements manufactured from magnesium oxide are chemically compatible with molten magnesium yet these have to be fired at very high temperatures of over 1600° C. heated to sinter the magnesium oxide. As well known in the art, heating to these high temperatures is costly. High volumes of filters cannot be manufactured at a cost which makes the filters commercially viable. The economical availability of magnesium oxide filters would increase the availability of magnesium and magnesium alloys for further development.

There has been a desire in the art for a filter which can be used to remove entrained solids from molten magnesium and molten magnesium alloy. This desire is accomplished by the present invention which provides an advance in the art of filter technology and greatly increases the availability of purified magnesium and magnesium alloys for further development.

### SUMMARY

It is an object of the present invention to provide a porous filter which can be used to remove entrained solids from molten magnesium and magnesium alloys.

It is a further object of the present invention to provide a porous filter of magnesium oxide which can be sintered at commercially attractive temperatures.

A particular feature of the present invention is the ability to provide a process for filtering molten magnesium which is cost effective, and wherein the filter is stable under the rigorous conditions associated with filtering molten magnesium.

These and other advantages, as will be realized, are provided in a filter for filtering molten metal. The filter comprises about 50-99.5%, by weight, MgO; and about 0.5-50%, by weight, at least one compound selected from a group consisting of TiO₂, ZrO₂,CaO₂, SiO₂, Al₂O₃ and Fe₂O₃.

A particularly preferred filter is prepared by the process of:

a) forming a slurry comprising a ceramic component wherein the ceramic component comprises:

50-99.5%, by weight, magnesium measured as the oxide; and

0.5-50%, by weight, at least one sintering aid selected from a group consisting of TiO₂, ZrO₂, CaO₂, SiO₂, Al₂O₃ and Fe₂O₃;

b) coating the slurry on an open cell organic foam material to form a coated material;

c) heating the coated material at a temperature sufficient to burn off the open cell organic foam material to form a structure; and

d) sintering said structure to form said filter.

A particularly preferred process for filtering metal is provided in the steps of:

a) melting the metal;

b) passing the molten metal through a porous filter wherein the porous filter comprises a primary ceramic component wherein the primary ceramic component consist essentially of:

50-99.5%, by weight, MgO; and

0.5-50%, by weight, at least one sintering aid selected from a group consisting of TiO₂, ZrO₂, CaO₂, SiO₂, Al₂O₃ and Fe₂O₃; and

c) cooling the molten metal to form a purified metal.

A particularly preferred embodiment is provided in a filter for filtering molten magnesium. The filter comprises about 90-99.5%, by weight, MgO; and about 0.5-10%, by weight, at least one compound selected from a group consisting of TiO₂, ZrO₂, CaO₂, SiO₂, Al₂O₃ and Fe₂O₃.

### DETAILED DESCRIPTION

The present invention relates to ceramic filters which contain three-dimensional interconnected pores. The molten metal passes through the pores. Entrained and liquid inclusions are excluded from passing through the pores thereby concentrating the inclusions in the filter while purified molten metal passes through the filter.

Ceramic filter elements are preferably prepared by the manner described in U.S. Pat. No. 4,056,586, which is incorporated herein by reference. Further elaboration on methods for manufacturing ceramic filter elements is provided in U.S. Pat. Nos. 5,673,902 and 5,456,833, both of which are included herein by reference.

The ceramic filter is prepared by a process of thoroughly coating a reticulated polyurethane foam precursor with a slurry comprising a ceramic component. Initial heating causes the liberation of volatile compounds such as solvents. Further heating incinerates and vaporizes the organic precursor and other organic materials in the slurry. Even further heating sinters the ceramic. The heating profile is not limiting. In practice, the heating profile may involve a linear temperature ramp over a set time with a hold time at high temperature. The heating profile may also involve temperature ramps with hold times for solvent removal, foam incineration and sintering. The heating may also involve three distinct processes with a hold time between subsequent heating periods.

More specifically, a slurry comprising a primary ceramic component is prepared in a suitable solvent such as water. The slurry is thoroughly mixed by batch mixing, ball milling or the like. The primary ceramic component preferably comprises metal compounds which are either oxides or materials which form oxides upon heating to sintering temperatures.

The slurry may comprise additional components such as binders, wetting aids, dispersing agents, etc. For the purposes of the present invention the slurry components are not particularly limiting. Those specifically described are exemplary and provided for the purposes of fully describing the manner in which the invention can be utilized by one of ordinary skill in the art. Components which may beneficially be added to the slurry include binders such as gums, starches and polymeric materials; forming aids, such as surfactants; organic thickening agents; wetting agents; antifoaming agents; etc.

The ceramic component of the slurry comprises an primary ceramic component consisting of a host ceramic and sintering aids which decrease the temperature at which the host can be sintered. The ceramic component may also comprise a secondary ceramic component which is the result of impurities which are inherent in oxides. The host is magnesium, preferably as the oxide, which represents at least approximately 50%, by weight, of the primary ceramic component. Below approximately 50%, by weight, magnesium oxide the advantages of the resulting filter began to deteriorate thereby mitigating those advantages which are provided by the present invention. The primary ceramic component preferably comprises no more than approximately 99.5% magnesium oxide. Above approximately 99.5% magnesium oxide the temperature required to sinter the filter is extremely high and the resulting filter is therefore costly to manufacture. It has been discovered through diligent experimentation that small amounts of specific sintering aids added to the ceramic component are sufficient to greatly decrease the temperature at which the filter must be heated for sintering. More preferably, the primary ceramic component comprises 75-99.5%, by weight, magnesium oxide. Most preferable is an primary ceramic component comprising 90-99.5%, by weight, magnesium oxide and most preferably the primary ceramic component comprises 97-99.5%, by weight, magnesium oxide.

It is well known in the art that metal oxides contain some level of impurity. Magnesium oxide, for example, may typically include up to 5 weight percent impurities without departing from the invention. These impurities may include oxides of calcium, silicon, iron and aluminum. Magnesium oxide, which is not highly purified, can be used and may be advantageous due to the lower cost relative to the cost associated with highly purified materials. The impurity oxides may represent an active, but secondary, ceramic component which become included impurities in the resulting filter. For the purposes of the present invention primary ceramic component refers specifically to the magnesium and sintering aids specifically recited and secondary ceramic component refers to the precursors or oxides of impurities.

The primary ceramic component preferably comprises at least approximately 0.5%, by weight, sintering aid to no more than about 50%, by weight, sintering aid selected from TiO₂, ZrO₂, CaO₂ SiO₂, Al₂O₃ and Fe₂O₃. Below approximately 0.5%, by weight, sintering aid the temperature required to sinter the magnesium oxide is not sufficiently lowered. Above approximately 50%, by weight, sintering aid the characteristics of the filter no longer have the desired stability associated with a magnesium oxide based filter. It would be understood to one of ordinary skill in the art that the weight ratio of magnesium element to that of the metal element of the sintering aids is the same in the slurry and resulting filter. The weight ratio of materials added to the slurry is easily adjusted to insure that the resulting oxides are in the appropriate weight ratios. In the present invention all weight ratios are based on the equivalent weight of the oxide unless otherwise stated.

Titanium compound sintering aids include titanium oxide. The preferred titanium compound sintering aid is titanium oxide (TiO₂). Titanium oxide is less stable towards molten magnesium and therefore it is preferred that the primary ceramic component comprise approximately 0.5-5%, by weight, titanium oxide. More preferably, the primary ceramic component comprises approximately 0.5-3%, by weight, titanium oxide. Titanium oxides are the most preferred sintering aids.

Zirconium compound sintering aids include zirconium oxide (ZrO₂). The preferred zirconium compound sintering aid is zirconium oxide. A preferred primary ceramic component comprises approximately 0.5-25%, by weight, zirconium oxide. More preferably, the primary ceramic component comprises approximately 0.5-5%, by weight, zirconium oxide. Most preferably, the primary ceramic component comprises approximately 0.5-3%, by weight, zirconium oxide.

The slurry is coated on a reticulated foam, preferably a reticulated polyurethane foam as known in the art. The reticulated foam is preferably an open pore structure wherein the slurry enters the pores. It is common to remove excess slurry and to compress the foam in the presence of slurry to insure that the slurry uniformly coats the foam webs.

After impregnating the foam with slurry the solvent is removed, preferably by heated evaporation.

The foam and organic components are burned off and the ceramic sintered by heating at a temperature of at least approximately 1500° C. to 1600° C. It is particularly preferred to sinter the ceramic and burn off the organic phase at a temperature of approximately 1550° C.

### EXAMPLE 1

A slurry was prepared by mixing 100 g of fused magnesium oxide, 3 g of titanium dioxide, 30 g of water, 0.4 g of Darvan 811, 0.25 g of Aquathix and 5 g of polyvinyl alcohol. Fused magnesium oxide is available in approximately 96-98% purity, with an average particle size of approximately 0.3 micron, as Dynamag K grade magnesium oxide from Washington Mills. Titanium oxide is available with a purity of greater than 99% and a particle size of approximately 12 microns as Pigment White 6 from Whittaker, Clark & Daniels, Inc. Aquathix is a polysaccharide available from Huls America, Inc. Darvan 811 is a dispersing agent available from R. T. Vanderbilt Company, Inc. Polyvinyl alcohol is available as Airvol 21-205 from Celanese Ltd.

The Aquathix was added to water and mixed at between 2000 and 2500 rpm using a Cowles Dissolver Model 1.VG.1. After the Aquathix gelled the Darvan 811 was added to the mixing slurry. The titanium dioxide and magnesium oxide were added and mixed for an additional 10 minutes followed by addition of polyvinyl alcohol and additional mixing for 5 minutes. A standard foam filter was impregnated with the slurry using standard techniques to a target density range of approximately 10-18% relative to the density of the solid MgO ceramics. The impregnated foam filter was fired at 1550° C. for 3 hours resulting in a shrinkage of 11-13%. The modulus of rupture (MOR) was measured at room temperature (RT) using a sample size of 6″×3″×1″ and a hot temperature (HT) of 800° C. with a sample size of 3″×3″×1″. The results presented in Table 1 are the average MOR of 10 samples. A three point bending method with a span of 4 inches and a loading of 0.1 inch/minute was used to determine room temperature MOR. For hot temperature MOR a span of 2.75 inches with the load applied at 0.5 inches/minute was used. The results are provided in Table 1.

TABLE 1

| | RT | HT |
|---|---|---|
| MOR (psi) | 199 | 77 |
| Average Density (%) | 11.80 | 12.04 |
| Minimum Density (%) | 10.96 | 11.14 |
| Maximum Density (%) | 12.81 | 12.07 |
| Density Standard Deviation (%) | 0.674 | 0.582 |

The results show that the resulting MgO filter has a high cold and hot strength which are required for the filtration of magnesium metal.

### EXAMPLE 2

A series of slurries were prepared as described in Example 1 with sintering aids TiO₂, ZrO₂ and CaCO₃ added in the amounts shown in Table 2. The slurries were dried in an oven, broken up and ground with a pestle and mortar to make powders for dry pressing. The powder was pressed into discs 1.012 inch in diameter and 0.25 inches thick at 10,000 lbs using a Carver Press. The discs were then fired at 1550° C. for three hours. The percent shrinkage was measured and is reported in Table 2. It is known in the art that the percent shrinkage increases with the degree of sintering. Increased shrinkage indicates increased sintering which is desirable.

TABLE 2

| Sample | MgO | TiO₂ | CaCO₃ | ZrO₂ | Shrinkage |
|---|---|---|---|---|---|
| 1 | 100% | | | | 3.11% |
| 2 | 99.01% | 0.99% | | | 6.13% |
| 3 | 97.08% | 2.92% | | | 9.07% |
| 4 | 99.01% | | | 0.99% | 3.60% |
| 5 | 97.08% | | | 2.92% | 5.24% |
| 6 | 99.01% | | 0.99% | | 2.85% |
| 7 | 97.08% | | 2.92% | | 3.2% |

The results of Table 2 clearly indicate the advantages provided by titanium and zirconium as sintering aids. Calcium carbonate does not improve sintering at these temperatures as effectively as TiO₂ or ZrO₂. Titanium is particularly advantageous as a sintering aid as indicated by sample 3 which indicates a shrinkage of over 9%. These results are neither expected nor predicted by those of skill in the art and are only arrived at with diligence.

The invention has been described with particular emphasis drawn to the preferred embodiments. The invention is set forth more specifically in the claims which follow.

1. A filter for filtering molten metal comprising:
about 50-99.5%, by weight, MgO; and
about 0.5-50%, by weight, at least one compound selected from a group consisting of TiO₂, ZrO₂, CaO₂, SiO₂, Al₂O₃ and Fe₂O₃.

2. The filter for filtering molten metal of claim 1 comprising:
about 75-99.5%, by weight, MgO; and
about 0.5 to 25%, by weight, at least one compound selected from the group consisting of TiO₂ and ZrO₂.

3. The filter for filtering molten metal of claim 2 comprising:
90-99.5%, by weight, MgO.

4. The filter for filtering molten metal of claim 3 comprising:
0.5-5%, by weight, TiO₂.

5. The filter for filtering molten metal of claim 4 comprising:
1-3%, by weight TiO₂.

6. The filter for filtering molten metal of claim 1 comprising:
0.5-25%, by weight, ZrO₂.

7. The filter for filtering molten metal of claim 6 comprising:
0.5-3%, by weight, ZrO₂.

8. A filter prepared by the process of:
forming a slurry comprising a ceramic component wherein said ceramic component comprises:
50-99.5%, by weight, magnesium measured as the oxide; and
0.5-50%, by weight, at least one sintering aid selected from a group consisting of TiO₂, ZrO₂, CaO₂ SiO₂, Al₂O₃ and Fe₂O₃;
coating said slurry on a reticulated organic foam material to form a coated material;
heating said coated material at a temperature sufficient to burn off said open cell organic foam material to form a structure; and
sintering said structure to form said filter.

9. The filter prepared by the process of claim 8 wherein said ceramic component comprises:
90-99.5%, by weight, magnesium measured as the oxide; and
0.5-10%, by weight, said at least one sintering aid.

10. The filter prepared by the process of claim 13 wherein said sintering aid is TiO₂.

11. The filter prepared by the process of claim 9 wherein said sintering aid is ZrO₂.

12. A process for purifying metal comprising the steps of:
melting said metal;
passing said metal through a porous filter prepared by the process of claim 8; and
cooling said molten metal to form a purified metal.

13. A magnesium metal purified by the filter prepared by the process of claim 8.

14. A process for purifying metal comprising the steps of:
melting said metal;
passing said molten metal through a porous filter wherein said porous filter comprises a primary ceramic component wherein said primary ceramic component consist essentially of:
50-99.5%, by weight, MgO; and
0.5-50%, by weight, at least one sintering aid selected from a group consisting of TiO₂, ZrO₂, CaO₂, SiO₂, Al₂O₃ and Fe₂O₃; and
cooling said molten metal to form a purified metal.

15. The process for purifying metal of claim 14 wherein said metal comprises magnesium.

16. The process for purifying metal of claim 15 wherein said metal consist essentially of magnesium.

17. A filter for filtering molten magnesium comprising:
about 90-99.5%, by weight, MgO; and
about 0.5-10%, by weight, at least one compound selected from a group consisting of TiO₂, ZrO₂,CaO₂, SiO₂, Al₂O₃ and Fe₂O₃.

18. The filter for filtering molten magnesium of claim 17 wherein said compound is TiO₂.

19. The filter for filtering molten magnesium of claim 17 wherein said compound is ZrO₂.

20. The filter for filtering molten magnesium of claim 17 wherein said filter comprises a primary ceramic component and said primary ceramic component comprises 97-99.5%, by weight MgO.

21. The filter for filtering molten magnesium of claim 20 wherein said primary ceramic component consist essentially of 97-99.5%, by weight, MgO and 0.5-3%, by weight, TiO₂.
